(19) United States
(12) Patent Application Publication
(10) Pub. No.: US 2024/0282980 A1
(43) Pub. Date: Aug. 22, 2024

(54) ALKALINE AMINE FUEL CELL

(71) Applicant: Utah Valley University, Orem, UT (US)

(72) Inventor: Kevin Shurtleff, Orem, UT (US)

(21) Appl. No.: 18/443,175

(22) Filed: Feb. 15, 2024

Related U.S. Application Data
(60) Provisional application No. 63/446,679, filed on Feb. 17, 2023.

(51) Int. Cl. H01M 8/0232; H01M 4/88; H01M 4/90; H01M 8/0247; H01M 8/04276; H01M 8/04791; H01M 8/083

(52) U.S. Cl. CPC H01M 8/0232; H01M 4/8853; H01M 4/9083; H01M 8/0247; H01M 8/04276; H01M 8/04798; H01M 8/083; H01M 2300/0014

(57) ABSTRACT

A fuel cell includes an anode, a cathode, and an electrolyte disposed between the anode and the cathode. The electrolyte includes an alkaline solution. The alkaline solution includes an amine compound. A plurality of fuel cells may be connected in series to provide a fuel cell stack with a plate disposed between the anode of a first fuel cell of two adjacent fuel cells of the plurality of fuel cells and the cathode of a second fuel cell of the two adjacent fuel cells of the plurality of fuel cells.

### CROSS-REFERENCES TO RELATED APPLICATIONS

This application claims the benefit of U.S. Provisional Patent Application No. 63/446,679 entitled “ADVANCED ALKALINE AMINE FUEL CELL” and filed on Feb. 17, 2023 for Kevin Shurtleff, which is incorporated herein by reference for all purposes.

### FIELD

This invention relates to fuel cells and more particularly relates to an alkaline amine fuel cell.

### BACKGROUND

Fuel cells can be clean and efficient means of converting chemical energy into electrical energy. Fuel cells can be used to provide power to, for example, vehicles, equipment, data centers, generators, and/or energy grids. An alkaline fuel cell (“AFC”) is a type of fuel cell that uses hydrogen and oxygen to generate electricity through an electrochemical reaction via an alkaline solution. A problem with current fuel cells is the cost of the fuel cells.

### SUMMARY

A fuel cell is disclosed. The fuel cell includes an anode, a cathode, and an electrolyte disposed between the anode and the cathode. The electrolyte includes an alkaline solution. The alkaline solution includes an amine compound.

Another fuel cell includes an anode, a cathode, and an electrolyte disposed between the anode and the cathode, the electrolyte comprising an alkaline solution where at least one of the anode and the cathode comprises a carbon cloth coated with a catalyst.

A fuel cell stack also includes a plurality of fuel cells electrically connected in series. Each fuel cell includes an anode, a cathode, and an electrolyte disposed between the anode and the cathode, the electrolyte comprising an alkaline solution, the alkaline solution comprising an amine compound. The fuel cell stack includes a plate disposed between the anode of a first fuel cell of two adjacent fuel cells of the plurality of fuel cells and the cathode of a second fuel cell of the two adjacent fuel cells of the plurality of fuel cells.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a schematic block diagram illustrating one embodiment of a system including a fuel cell stack;

FIG. 1B is a perspective view illustrating one embodiment of a system including a fuel cell stack;

FIG. 2A is a schematic diagram illustrating one embodiment of a fuel cell;

FIG. 2B is an exploded view illustrating one embodiment of a fuel cell;

FIG. 3 is a schematic block diagram illustrating one embodiment of a fuel cell stack; and

FIG. 4 is a perspective view illustrating one embodiment of a system for coating an electrode of a fuel cell with a catalyst.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system and/or method. Accordingly, aspects of the controller of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

Embodiments of the present disclosure include a fuel cell. The fuel cell includes an anode, a cathode, and an electrolyte disposed between the anode and the cathode. The electrolyte includes an alkaline solution. The alkaline solution includes an amine compound.

In some examples, at least one of the anode and the cathode comprises a carbon cloth coated with a catalyst. In some embodiments, the fuel cell includes a plate. The plate includes an opening configured to receive a gas. In the embodiments, the fuel cell includes a diffuser disposed between the plate and at least one of the anode and the cathode and configured to form electrical contact between the plate and the at least one of the anode and the cathode. The diffuser includes a material, and the material is elastic, mesh, and/or metallic. The catalyst is configured to react with the gas as the gas is diffused by the diffuser.

In some examples, the plate is a first plate positioned at a first end. The first plate includes a first opening configured to receive hydrogen, a second opening configured to allow the hydrogen to exit the fuel cell, a third opening configured to receive the electrolyte, and a fourth opening configured to allow the electrolyte to exit the fuel cell. In the examples, the fuel cell includes a second plate positioned at a second end of the fuel cell opposite to the first end. In the examples, the second plate includes a fifth opening configured to receive oxygen and a sixth opening configured as an exit for the oxygen. In further examples, the fuel cell includes a concentrator positioned proximate to the fifth opening. In the examples, the oxygen includes oxygen in a gas, and the concentrator is configured to increase a concentration of oxygen in the gas.

In some embodiments, the fuel cell includes a membrane separator disposed between the cathode and the anode. The membrane separator includes a material that is electrically insulating, is inert to the amine compound, and/or is porous to the amine compound. In some embodiments, the alkaline solution includes a liquid solution and the electrolyte includes an organic amine compound. In some embodiments, the organic amine compound includes dibutylamine, tripropylamine, and/or dihexylamine. In some embodiments, the amine compound has a density, at 25 degrees Celsius, of not greater than 1 gram per milliliter.

Embodiments of the present disclosure include another fuel cell. The fuel cell includes an anode, a cathode, and an electrolyte disposed between the anode and the cathode. The electrolyte includes an alkaline solution. At least one of the anode and the cathode includes a carbon cloth coated with a catalyst.

In some embodiments, the alkaline solution includes an amine compound. In some embodiments, the fuel cell includes a membrane separator disposed between the cathode and the anode. The membrane separator includes a material that is electrically insulating, is inert to the amine compound, and/or is porous to the amine compound.

In some embodiments, the fuel cell includes a reservoir configured to receive the alkaline solution, and water of the alkaline solution is separated from the amine compound as the alkaline solution passes through the reservoir. In the embodiments, the reservoir includes a drain, a sensor configured to determine a water level of the reservoir, and a controller. In the embodiments, the controller is configured to determine, based at least in part on data received from the sensor, that a water level of the reservoir is greater than or equal to a threshold water level, and, in response to the determining, perform at least one of: to transmit a notification to a user and/or to actuate opening of the drain.

In some embodiments, the fuel cell includes a plate the includes an opening configured to receive a gas, and a diffuser disposed between the plate and at least one of the anode and the cathode and configured to form electrical contact between the plate and the at least one of the anode and the cathode. The diffuser includes a material that is clastic, mesh, and/or metallic. The catalyst is configured to react with the gas as the gas is diffused by the diffuser. In further embodiments, the opening is a first opening of the plate, and the plate includes a first corner. In the embodiments, the first opening is positioned proximate to the first corner. In the embodiments, the plate includes a second corner opposite to the first corner and a second opening configured as an exit for the gas and positioned proximate to the second corner.

In some embodiments, the catalyst includes a number of particles deposited onto the carbon cloth via pulsed electro-deposition. The number of particles include non-platinum particles. In some embodiments, the number of particles include nickel and/or silver. In some embodiments, the anode includes the carbon cloth, and/or the catalyst includes nickel particles. In some embodiments, the carbon cloth is a first carbon cloth and/or the cathode includes a second carbon cloth coated with a number of silver particles.

Embodiments of the present disclosure include a fuel cell stack. The fuel cell stack includes a plurality of fuel cells electrically connected in series. Each fuel cell includes an anode, a cathode, and an electrolyte disposed between the anode and the cathode. The electrolyte includes an alkaline solution and the alkaline solution includes an amine compound. The fuel cell stack includes a plate disposed between the anode of a first fuel cell of two adjacent fuel cells of the plurality of fuel cells and the cathode of a second fuel cell of the two adjacent fuel cells of the plurality of fuel cells.

A hydrogen fuel cell is an electrochemical converter. It uses oxidation-reduction reactions (redox reaction) to convert the chemical energy in hydrogen and oxygen into water and electricity. An alkaline fuel cell (AFC) is a type of hydrogen fuel cell. In an alkaline fuel cell, hydrogen introduced at the anode is oxidized, releasing electrons to the external circuit, and producing water. Oxygen (for example, in a stream of air) is reduced at the cathode, accepting electrons from the external circuit. The hydrogen oxidation reaction (HOR), the oxygen reduction reaction (ORR), and the overall reaction for the alkaline fuel cell are shown in Equation 1, 2, and 3, respectively.

$$Anode ( - ) : 2 {H}_{2} + 40 H - \to 4 {H}_{2} 0 + 4 {e}^{-} \qquad ( 1 )$$

$$Cathode ( + ) : {O}_{2} + 2 {H}_{2} O + 4 e - \to 4 O {H}^{-} \qquad ( 2 )$$

$$Overall : 2 {H}_{2} + {O}_{2} \to 2 {H}_{2} O \qquad ( 3 )$$

Alkaline fuel cells can help to reduce fuel cell costs in comparison to other types of fuel cells by using more cost-effective catalysts and other components. Conventional alkaline fuel cells often use potassium hydroxide as an electrolyte and can experience a degradation in performance, due in part to reactions between carbon dioxide in the hydrogen and/or air stream with the electrolyte to form carbonate precipitates that coat the catalysts, reducing the effectiveness of the catalysts. Water produced at an anode of an alkaline fuel cell can dilute the electrolyte and also contribute to performance degradation.

Examples of the present disclosure help to improve the performance of fuel cells. Examples of the present disclosure include an alkaline fuel cell having an amine compound electrolyte. Embodiments of the present disclosure can help to reduce electrolyte dilution and/or extend the life of the fuel cell and/or catalysts of the fuel cell. Embodiments of the present disclosure also include a fuel cell including one or more electrodes that include a carbon cloth coated with a catalyst. Embodiments of the present disclosure help to produce efficient, cost-effective electrodes for fuel cells.

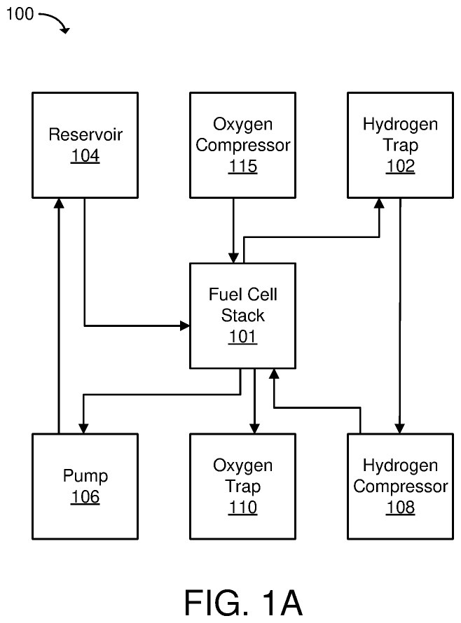

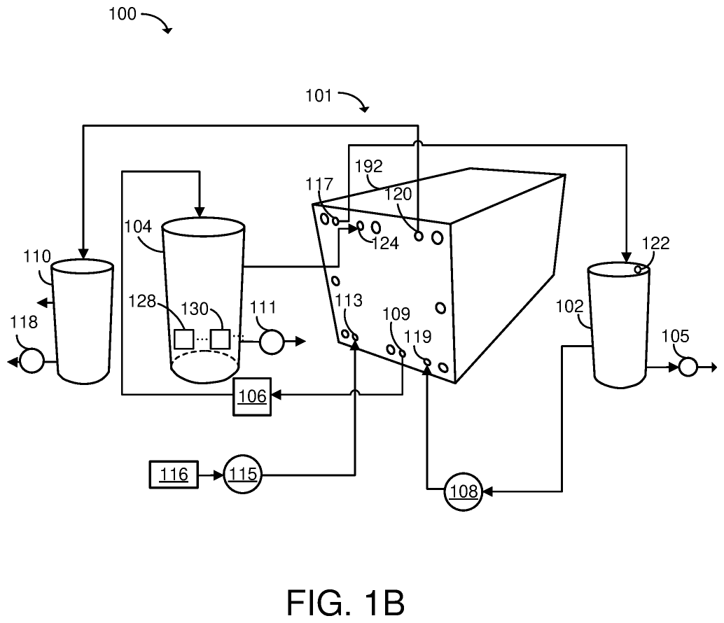

FIG. 1A is a schematic block diagram illustrating one embodiment of a system 100. As shown in FIG. 1A, in some embodiments, the system 100 includes a fuel cell stack 101, a hydrogen trap 102, a reservoir 104, a pump 106, a hydrogen compressor 108, an oxygen trap 110, and an oxygen compressor 115, which are described below. FIG. 1B is a perspective view illustrating one embodiment of the system 100. As shown in FIG. 1B, in some embodiments, the fuel cell stack 101 includes a housing 192.

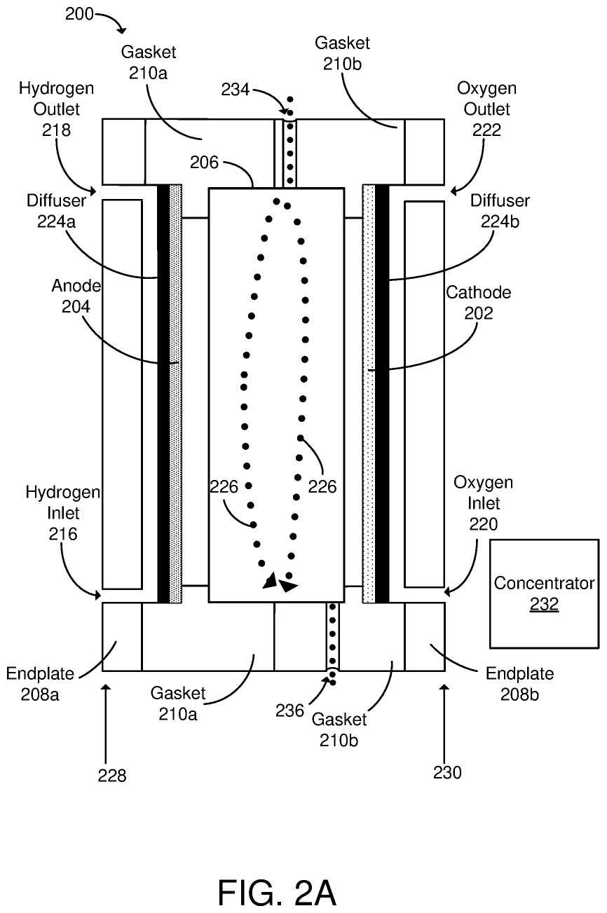

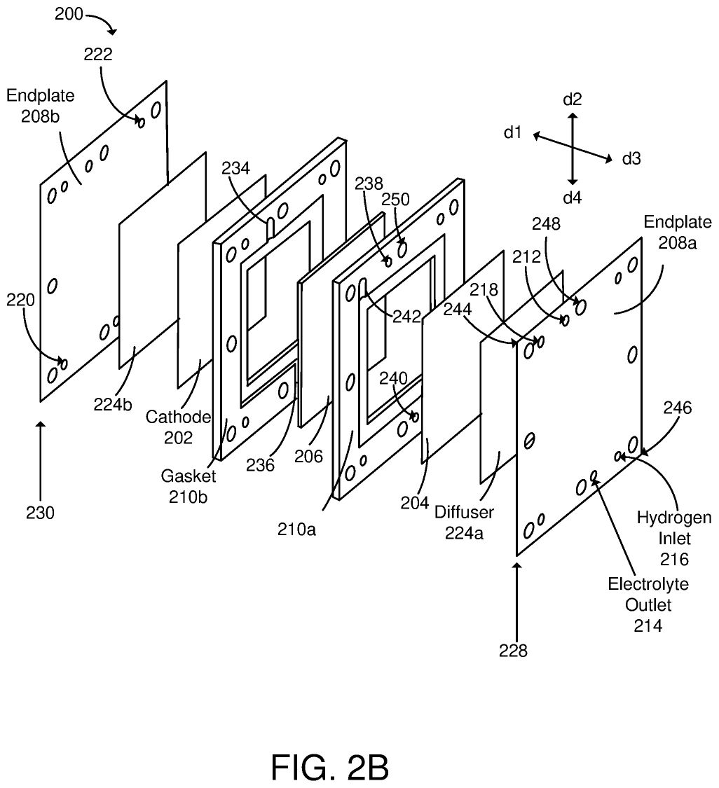

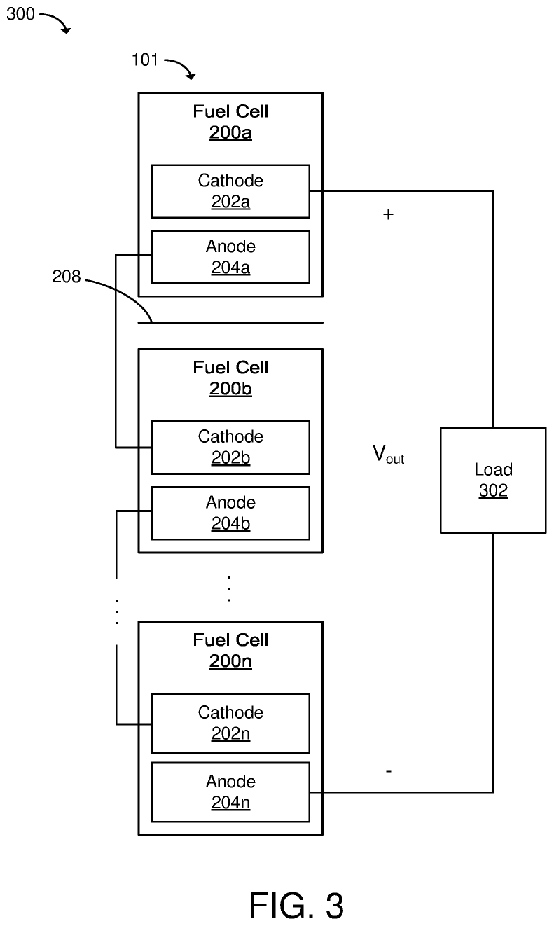

In some embodiments, the fuel cell stack 101 includes a number of fuel cells (e.g., fuel cells 200 shown in FIG. 2A-3). In some embodiments, the fuel cell stack 101 receives hydrogen. In some embodiments, the fuel cell stack 101 receives the hydrogen from the hydrogen trap 102. As shown in FIG. 1A, in some embodiments, the fuel cell stack 101 receives the hydrogen via a hydrogen compressor 108. As shown in FIG. 1B, in some embodiments, the fuel cell stack 101 receives the hydrogen via a hydrogen inlet 119 in the fuel cell stack housing 192. In some embodiments, the hydrogen inlet 119 includes an opening. In some embodiments, the hydrogen inlet 119 is positioned proximate to a corner of the fuel cell stack 101.

In some embodiments, the hydrogen then diffuses throughout the fuel cell stack 101, reacting with catalysts. In some embodiments, excess hydrogen exits the fuel cell stack 101 via a stack hydrogen outlet 117 in the housing 192. In some embodiments, stack hydrogen outlet 117 is positioned proximate to a corner that is opposite to the hydrogen inlet 119, which can help to increase the hydrogen's exposure to reactive components within the fuel cell stack 101, such as the anodes 204 of each fuel cell 200. In other embodiments, the fuel cell stack 101 includes multiple inlets and/or outlets for hydrogen. In some embodiments, the excess hydrogen is then fed back into the hydrogen trap 102 via a hydrogen port 122 in the hydrogen trap 102. In some embodiments, the hydrogen trap 102 includes a hydrogen drain 105 configured to serve as an exit from the hydrogen trap 102. In some embodiments, the hydrogen drain 105 includes a valve.

In some embodiments, the fuel cell stack 101 receives oxygen. In some embodiments, the fuel cell stack 101 receives the oxygen from the oxygen compressor 115. As shown in FIG. 1B, in some embodiments, the oxygen compressor 115 includes an oxygen filter 116. In some embodiments, the filter 116 is configured to remove dust particles. In some embodiments, the fuel cell stack 101 receives oxygen at a cathode via an oxygen inlet 113 in the housing 192. In some embodiments, the oxygen diffuses throughout the fuel cell stack 101 and exits the stack 101 via an oxygen outlet 120 in the housing 192. In some embodiments, the oxygen inlet 113 is positioned proximate to a corner of the fuel cell stack housing 192 that is opposite to a corner of the fuel cell stack housing 192 proximate to which the oxygen outlet 120 is positioned. In other embodiments, the fuel cell stack 101 includes multiple inlets and/or outlets for oxygen. In some embodiments, the oxygen exits the housing 192 and is fed into the oxygen trap 110. In some embodiments, the oxygen trap 110 includes an oxygen drain 118 configured to serve as an exit for the oxygen from the oxygen trap 110.

In some embodiments, the fuel cell stack 101 includes fuel cells 200 having alkaline solution electrolytes 226, as shown in FIGS. 2A-B. In some embodiments, the reservoir 104 is configured to receive the alkaline solution from the fuel cell stack 101 after it is circulated throughout the fuel cell stack 101. In some embodiments, the alkaline solution flows out of the fuel cell stack 101 from an electrolyte outlet 109 and to the pump 106. In some embodiments, the pump 106 pumps the alkaline solution into the reservoir 104. In some embodiments, the pump 106 also pumps the alkaline solution through a cooling radiator and then into the reservoir 104. In some embodiments, the reservoir 104 also acts as a separator. In some embodiments, water of the alkaline solution is separated from an amine compound of the alkaline solution as the alkaline solution passes through the reservoir 104. In some embodiments, the amine compound then flows from the reservoir and into the fuel cell stack 101 via a stack electrolyte inlet 124. In some embodiments, the electrolyte is then re-circulated back through the fuel cell stack 101. In some embodiments, the reservoir 104 includes heating elements configured to increase the temperature of an alkaline solution within the reservoir 104 and prepare it for re-use in the fuel cell stack 101.

In some embodiments, reservoir 104 includes a drain 111. In some embodiments, the drain 111 is configured to serve as an exit from the reservoir for water and/or the alkaline solution. In some embodiments, the system 100 includes a sensor 128. In some embodiments, the sensor 128 is a water level sensor configured to determine a water level of the reservoir 104. In some embodiments, the sensor 128 is positioned within the reservoir 104. In some embodiments, the sensor 128 is in communication with a controller 130. In some embodiments, the controller 130 is configured to receive a signal that represents a water level from the sensor 128. In some embodiments, the controller 130 is configured to determine when the water level of the reservoir 104 is greater than or equal to a threshold water level.

In some embodiments, the controller 130 is configured to, based at least in part on determining that the water level is above a threshold level, transmit a notification to a user. In some embodiments, the controller 130 is configured to transmit the notification to a computing device associated with a user. In some embodiments, the notification indicates that the water level of the reservoir 104 is high and/or that the reservoir 104 should be drained. In some embodiments, the controller 130 is configured to actuate opening of the drain 111. In some embodiments, the controller 130 determines that the water level is above a threshold water level and actuates opening the drain 111 to lower the water level. In the embodiments, the controller 130 may then close the drain 111 after a certain period of time, after a sensor determines that the water level in the reservoir 104 is below a lower level, or the like.

FIG. 2A is a schematic diagram illustrating one embodiment of a fuel cell 200. FIG. 2B is an exploded view illustrating one embodiment of the fuel cell 200. In some embodiments, the fuel cell 200 is a fuel cell of the fuel cell stack 101. In some embodiments, the fuel cell 200 includes an anode 204, a cathode 202, a separator 206, one or more endplates 208a and 208b (referred to herein, individually, and/or collectively, as “208”), one or more gaskets 210a and 210b (referred to herein, individually, and/or collectively, as “210”), and an electrolyte 226.

In some embodiments, the fuel cell 200 includes an electrolyte 226. As shown in FIG. 2A, in some embodiments, the electrolyte 226 enters a cavity of the fuel cell 200 through a first groove 234, is circulated between the electrodes of the fuel cell 200, and exits the cavity via a second groove 236. As used herein, the term “electrodes” refers to one or both of the anode 204 and the cathode 202. As used herein, the term “disposed,” when referring to the electrolyte 226, can refer to an electrolyte 226 being circulated between the anode 204 and the cathode 202 (e.g., circulated and/or recirculated through a separator disposed between the electrodes).

In some embodiments, the electrolyte 226 includes an alkaline solution. In some embodiments, the electrolyte 226 includes a liquid solution. In some embodiments, the electrolyte 226 includes an aqueous alkaline solution.

In some embodiments, the alkaline solution includes an amine compound. In some embodiments, the amine compound acts as a charge carrier for the reaction within the fuel cell 200. In some embodiments, the electrolyte 226 includes an amine ion, tertiary ammonium (R₃NH⁺) that migrates from the anode 204 to the cathode 202. In some embodiments, the amine compound is an organic amine compound.

In some embodiments, the amine compound is selected based at least in part on melting point (“MP”), boiling point (“BP”), density, basicity, toxicity, flash point, and/or cost. In some embodiments, the amine compound has one or more of: a melting point to be liquid under ambient conditions, a low vapor pressure, a density less than 1 gram/milliliter (g/mL) at 4 degrees Celsius, a relatively high pKa, and/or any combination thereof. In some embodiments, the amine compound has a density that is less than that of water and/or less than that of water. In some embodiments, the lower density of the amine compound helps to allow water from the alkaline solution to settle below the amine compound. In some embodiments, the amine compound having a relatively high pKa helps to increase the production of hydroxide ion in the presence of water from the alkaline solution.

In some embodiments, the electrolyte 226 has a molecular weight (“MW”) in grams per mole (“g/mol”) of greater than and/or equal to 125. In some embodiments, the electrolyte 226 has a melting point (“MP”) of less than 10° C. In some embodiments, the electrolyte 226 has a boiling point greater than or equal to 130° C. In some embodiments, the electrolyte 226 includes an amine compound that has a density, at 25 degrees Celsius, of not greater than 1 gram per milli-liter (“g/mL”). In some embodiments, the electrolyte has a pKa of greater than or equal to 10. In some embodiments, the electrolyte 226 has a water solubility of greater than or equal to 4 grams/liter (“g/L”). Table 1, shown below, illustrates some examples of organic amine compounds. In some embodiments, the electrolyte 226 includes any one of the organic amine compounds listed in Table 1, as shown below. In some embodiments, the electrolyte 226 includes dibutylamine, tripropylamine, and/or dihexylamine.

TABLE 1

| | | | | | | | water | |
|---|---|---|---|---|---|---|---|---|
| | | | | | | | solubility | |
| | MW | M.P. | B.P. | Density | | Basicity | (g/100 g, | |
| Organic Electrolyte | (g/mol) | (° C.) | (° C.) | (g/mL) | pKa | (pKb) | H2O) | |
| ammonia | 17.031 | | −33.34 | 0.86 | 9.25 | 4.75 | miscible | |
| propylamine | 59.11 | | 47 | 0.719 | 10.71 | 3.29 | miscible | |
| N,N dipropylamine | 101.19 | | 109 | 0.738 | | | | |
| cyclohexylamine | 99.17 | | 134.5 | 0.8647 | 10.64 | 3.36 | miscible | |
| Methylamine | 31.06 | | | gas | | 3.38 | | |
| (Methanamine) | | | | | | | | |
| N,N dimethylamine | | | | gas | | 3.27 | | |
| (N-Methylmethanamine) | | | | | | | | |
| N,N,N trimethylamine | | | | gas | | 4.22 | | |
| (N,N-Dimethylmethanamine) | | | | | | | | |
| N ethylamine | | | | gas | | 3.29 | | |
| (Ethanamine) | | | | | | | | |
| N,N diethylamine (N- | 73.14 | | 54.8 | 0.7074 | | 3.00 | miscible | |
| Ethylethanamine) | | | | | | | | |
| N,N,N triethylamine (N,N- | 101.19 | | 88.6 | 0.7255 | 10.75 | 3.25 | 112 | g/L |
| Diethylethanamine) | | | | | | | | |
| Aniline | 93.13 | | 184.13 | 1.0217 | 4.62 | 9.38 | 36 | g/L |
| (Phenylamine)(Benzenamine) | | | | | | | | |
| benzylamine | 107.16 | | 185 | 0.981 | 8.82 | 4.66 | soluble | |
| (phenylmethylamine) | | | | | | | | |
| (Phenylmethanamine) | | | | | | | | |
| N-Methylaniline | 107.16 | | 194 | 0.99 | 4.85 | 9.30 | insoluble | |
| N,N-Dimethylaniline | 121.18 | | 194 | 0.956 | | 8.92 | 0.002 | |
| butylamine | | | | | | | Miscible | |
| dibutylamine | 129.247 | | 137 | 0.767 | 11.39 | | 4.7 | g/L |
| allylamine | 57.1 | | 55 | 0.763 | 9.49 | 4.51 | | |
| allyldimethylamine | | | | | | | | |
| allyldiethylamine | | | | | | | | |
| diallylmethylamine | | | | | | | | |
| Oleylamine | | | | | | | | |
| 1-Methylheptylamine (2-aminooctane) | | | | | | | | |
| diphenylamine | | | | | | | miscible | |
| dimethylethylamine | 73.14 | | 36.5 | 0.7 | | | | |
| tripropylamine | 143.27 | | 155 | 0.75 | 10.65 | | 6.65 | g/L |
| tributylamine | | | 216 | 0.78 | 10.9 | | 0.05 | g/L |
| pyrazine | | | 115 | | | | soluble | |
| 2-(Pyridin-2-yl)isopropyl | | | | 0.98 | | | | |
| amine | | | | | | | | |
| pyridine (cyclic amine, | | | | | 5.3 | | miscible | |
| benzene) | | | | | | | | |
| triphenylamine | | | | 0.774 | not | | insoluble | |
| | | | | | basic | | | |
| trihexylamine | | | | 0.794 | | | | |
| Dihexylamine (C12H27N) | 185.35 | −13 | 236 | 0.795 | 11 | | 12 | g/L |
| monoethanolamine (MEA) | 61.084 | | 170 | 1.012 | 9.5 | | miscible | |
| ethylene diamine | | | | 0.9 | | | miscible | |
| hexylamine (C6H15N) | 101.193 | −23.4 | 131.5 | 0.77 | 10.56 | | 4.96 | g/L |
| diethylenetriamine (DETA) | | | | | | | | |
| oleylamine (C18H37N, | 267.493 | 21 | 364 | 0.813 | 10.7 | | insoluble | |
| not saturated) | | | | | | | | |
| hexadecylamine (C16H35N) | 241.46 | 44 | | | 10.6 | | insoluble | |
| octadecylamine (C18H39N) | 269.5 | 53 | | | 10.65 | | 3.3E−5 | g/L |
| piperidine (hexyl cyclic | | | | | 11.2 | | miscible | |
| amine) | | | | | | | | |
| pentadecyl amine ( | | | | | | | | |
| N,N- | | | | | | | | |
| Dimethyltetradecylamine | | | | | | | | |
| dodecylamine (C12H25NH2), | 185.35 | 28 | 259 | 0.8 | 10.6 | | 0.078 | g/L |
| laurylamine | | | | | | | | |
| nonylamine (C9H19NH2) | | | | | | | | |
| decylamine (C10H21NH2) | | | | | | | | |
| octylamine (C8H17NH2) | 129.24 | 0 | 180 | 0.782 | 10.65 | | 0.2 | g/L |
| heptylamine (C7H15NH2) | | | | | | | | |
| trioctylamine ((C8H17)3N) | | | | | | | | |
| dioctylamine ((C8H17)2NH) | | | | | | | | |
| didodecylamine | | | | | | | | |
| didecylamine | | | | | | | | |
| diisopropylamine | | | | | | | miscible | |
| spermidine (C7H19N3) | 145.25 | | | 0.925 | | | 145 | g/L |
| found in tissue | | | | | | | | |
| methylethylamine | 59.11 | | | 0.688 | 10.54 | | 418 | g/L |

| monoethanolamine (MEA), ethanolamine | | 10.3 | 170 | | | miscible |
|---|---|---|---|---|---|---|
| diethanolamine (DEA) | 105.14 | | 269 | 1.09 | | miscible |
| triethanolamine (TEA) | | | | 1.124 | | miscible |
| methyldiethanolamine | | | | | | miscible |
| (MDEA) | | | | | | |
| 2-Amino-2-methylpropanol | | | | 0.934 | | insoluble |
| (AMP) | | | | | | |
| piperazine (PIPA) | | 106 | | | 9.8 | freely |
| | | | | | | soluble |
| diglycolamine | | | | 1.06 | | miscible |

As shown in FIGS. 2A and 2B, in some embodiments, the fuel cell 200 includes an anode 204 and a cathode 202. In some embodiments, the anode 204 is configured to convert hydrogen gas into hydrogen ions and electrons. In some embodiments, the cathode 202 is configured to convert oxygen, water from the electrolyte 226, and electrons from the anode 204 into hydroxide ions. In some examples, the hydroxide ions help to power a load, such as load 302 shown in FIG. 3.

In some embodiments, the fuel cell includes endplates 208a and 208b. In some embodiments, each endplate 208 includes a number of openings. In some embodiments, the openings include, but are not limited to, an electrolyte inlet 212, an electrolyte outlet 214, a hydrogen inlet 216, a hydrogen outlet 218, an oxygen inlet 220, and/or an oxygen outlet 222. In some embodiments, one or more of the endplates 208 includes a metallic material, such as a stainless-steel material. In some embodiments, each endplate 208 includes an opening configured to receive a gas, such as hydrogen and/or oxygen. In some embodiments, each endplate 208 also includes an opening configured as an exit for the gas.

In some embodiments, the fuel cell 200 includes a diffuser 224 disposed between the endplate 208 and an electrode and configured to diffuse the gas (e.g., hydrogen, oxygen). In some embodiments, each electrode includes a catalyst configured to react with the diffuser 224 as the gas is diffused by the diffuser 224. In some embodiments, the diffuser 224 is configured to diffuse the gas by spreading bubbles of the gas. In some embodiments, the diffuser 224 is configured to form electrical contact between the endplate 208 and an adjacent electrode (e.g., the first endplate 208a and the anode 204 and/or the second endplate 208b and the cathode 202). In some embodiments, the diffuser 224 acts as a compression spring between the endplate 208 and the adjacent electrode. In some embodiments, the diffuser 224 includes a material that is elastic, mesh, and/or metallic. In some embodiments, the diffuser 224 includes stainless steel mesh.

In some embodiments, the fuel cell 200 includes a first endplate 208a positioned at a first end 228 of the fuel cell 200. In some embodiments, the first endplate 208a includes a hydrogen inlet 216 and a hydrogen outlet 218. In some embodiments, the fuel cell 200 is configured to introduce hydrogen to the anode 204 via the hydrogen inlet 216. In some embodiments, the hydrogen undergoes oxidation after being introduced to the anode 204 and is split into protons and electrons. In some embodiments, hydrogen enters the fuel cell 200 via the hydrogen inlet 216, and the diffuser 224a disposed between the endplate 208a and the anode 204 diffuses the hydrogen. In some embodiments, the hydrogen reacts with the anode 204. In some embodiments, the anode 204 includes a carbon fiber cloth coated with a nickel catalyst to react with the hydrogen. In some embodiments, protons from the hydrogen move through the electrolyte 226 and towards the cathode 202. In some embodiments, electrons from the hydrogen move through an external circuit, such as the external circuit shown in FIG. 3, creating an electric current.

In some embodiments, the hydrogen enters the fuel cell in first direction d1 and travels up a groove 242 in the first gasket 210a in a second direction d2. In some embodiments, the hydrogen travels in a third direction d3 to exit the fuel cell 200 via the hydrogen outlet 218. In some embodiments, hydrogen flows into the hydrogen inlet 216 at a rate of approximately 1.7 liters per minute. In some embodiments, the first gasket 210a includes an additional groove not shown in FIG. 2B, and the hydrogen flows up the additional groove and is diffused by the diffuser 224a. In some embodiments, the diffused hydrogen flows up through the groove 242 and exits the fuel cell 200.

In some embodiments, the hydrogen inlet 216 is positioned proximate to a first corner 246 of the first endplate 208a. In some embodiments, the hydrogen outlet 218 is positioned proximate to a second corner 244. In some embodiments, the second corner 244 is opposite to the first corner 246. As used herein, the phrase “proximate to a corner” indicates that the opening is closer to that corner than to any other corner on the endplate 208. In some embodiments, positioning the hydrogen inlet 216 and hydrogen outlet 218 proximate to opposite corners 244 and 246 helps to increase the area of the anode 204 which the hydrogen contacts and reacts with. In other embodiments, the fuel cell 200 includes multiple hydrogen inlets and/or hydrogen outlets.

In some embodiments, the fuel cell 200 is configured to introduce oxygen to the cathode 202. In some embodiments, the oxygen combines with the hydrogen protons moving towards the cathode 202 and the hydrogen electrons to form water as a by-product of the reaction. In some embodiments, the water exits the fuel cell 200 and is moved to the reservoir 104.

In some embodiments, the fuel cell 200 includes a second endplate 208b positioned at a second end 230 opposite to the first end 228. In some embodiments, the second endplate 208b includes at least two openings. In some embodiments, the at least two examples include an oxygen inlet 220 and an oxygen outlet 222. In some embodiments, oxygen enters the fuel cell 200 via the oxygen inlet 220, is diffused by the diffuser 224b disposed between the endplate 208b and the cathode 202, and exits the fuel cell 200 via the oxygen outlet 222. In some embodiments, oxygen flows into the oxygen inlet 220 at a rate of approximately 4.0 liters per minute. In other embodiments, the fuel cell 200 includes multiple oxygen inlets and/or oxygen outlets.

In some embodiments, the first endplate 208a includes an electrolyte inlet 212 configured to allow the electrolyte 226 to enter the fuel cell 200. In some embodiments, the fuel cell 200 is configured to allow the electrolyte 226 to enter the fuel cell 200. In some embodiments, the electrolyte 226 is then dispersed within the fuel cell 200, between the anode 204 and the cathode 202. In some embodiments, the electrolyte inlet 212 is centered with respect to a top edge of the endplate 208a. In some embodiments, the electrolyte inlet 212 is positioned above the diffuser 224a. In some embodiments, the electrolyte enters via the electrolyte inlet 212, travels in a first direction d1 through a first opening 238 in the gasket 210a, and travels in a second direction d4 down a first groove 234 in the second gasket 210b. In some embodiments, the electrolyte 226 then travels in a parallel direction along the separator 206 and down the second groove 236 in the second gasket 210b. In some embodiments, the electrolyte 226 then travels through a second opening 240 in the first gasket 210a and out of the electrolyte outlet 214. In some embodiments, the electrolyte outlet 214 is positioned proximate to a bottom edge of the endplate 208a. In some embodiments, the electrolyte outlet 214 is substantially centered with respect to a bottom edge of the endplate 208a.

In some embodiments, the electrolyte outlet 214 allows water from the electrolyte 226 to exit the fuel cell 200, helping to prevent flooding of the fuel cell 200. In some embodiments, the electrolyte 226 separates into an amine phase and a water phase, with the water phase portion exiting the fuel cell 200 via the electrolyte outlet 214. Embodiments of the present disclosure help to reduce the amount of water dissolved from the electrolyte 226 before it separates into an amine phase and a water phase. As such, embodiments of the present disclosure can help to reduce dilution of the electrolyte 226 during operation.

In some embodiments, the gaskets 210 are disposed between the endplates 208. In some embodiments, each gasket 210 is disposed between an electrode and a separator 206. Although not completely shown in FIG. 2B, in some embodiments, the second gasket 210b includes a number of openings and a cathode-facing side with a number of grooves for circulation of oxygen throughout the cell. In some embodiments, each gasket 210 includes a side facing the separator 206 and including a number of grooves (e.g., grooves 234 and 236) and openings (e.g., opening 238) for circulation of the electrolyte 226 throughout the cell 200.

In some embodiments, the endplates 208 each include a number of bolt openings to allow for coupling of the components of the fuel cell 200 via bolt openings 250 in the gaskets 210. In some embodiments, the gaskets 210 include a polypropylene material. In some embodiments, each of the gaskets 210 includes a layer configured to seal the cell 200. In some embodiments, the layer coats the gasket 210 and includes a silicone material, such as room-temperature-vulcanizing silicone. In some embodiments, the first gasket 210a holds the anode 204, and the second gasket 210b holds the cathode 202. In some embodiments, the gaskets 210 include one or more openings and/or grooves.

In some embodiments, the separator 206 is a membrane separator disposed between the cathode 202 and the anode 204. In some embodiments, the separator 206 is configured to act as a barrier between the anode 204 and the cathode 202. In some embodiments, the separator is configured to prevent electrons from flowing directly between the anode 204 and the cathode 202. In some embodiments, the separator 206 is selectively permeable to ions, allowing ions and/or water to pass from the anode 204 to the cathode 202 to complete an electrochemical reaction. In some embodiments, the separator 206 includes a material that is electrically insulting. In some embodiments, the material is substantially inert to the amine compound. In some embodiments, the material is configured to not interact with the amine compound. In some embodiments, the material is porous to the amine compound. In some embodiments, the separator 206 includes a non-woven, cotton fiber cloth. In some embodiments, the separator 206 includes a woven material. In some embodiments, the separator 206 includes a material compatible with strong bases. In some embodiments, the separator 206 includes a material compatible with an alkaline amine electrolyte and/or potassium hydroxide electrolyte. In some embodiments, the fuel cell 200 includes several layers of the separator 206 disposed between the anode 204 and the cathode 202.

Referring to FIG. 2A, in some embodiments, the fuel cell 200 includes a concentrator 232. In some embodiments, the concentrator 232 is positioned proximate to the oxygen inlet 220 such that gas flows through the concentrator 232 before flowing into the oxygen inlet 220. In some embodiments, oxygen flowing into the oxygen inlet 220 is oxygen in gas. In some embodiments, the concentrator 232 is configured to increase a concentration of oxygen in the gas. In some embodiments, the concentrator 232 includes a rotating wheel made of a microporous material. In some embodiments, as the oxygen passes through the wheel, volatile organic compounds adhere to the surface of the wheel, and concentrated oxygen flows into the oxygen inlet 220. In some embodiments, the concentrator 232 includes a compressor 115 and a filter 116. In some embodiments, the filter 116 is configured to remove nitrogen from the gas, thus increasing the concentration of the oxygen in the gas entering the fuel cell 200. In some embodiments, the concentrator 232 is configured to double the percentage of oxygen in the gas. In some embodiments, the concentrator 232 is configured to receive gas having an oxygen concentration of approximately 20% and output a gas having an oxygen concentration of approximately 40%, feeding the outputted gas into the fuel cell 200. In some embodiments, increasing the concentration of oxygen helps to improve efficiency of the fuel cell 200.

FIG. 3 is a schematic block diagram illustrating one embodiment of a system 300 including a fuel cell stack 101. In some embodiments, the system 300 includes a fuel cell stack 101 connected across a load 302. In some embodiments, the system 300 is configured to provide power to the load 302. In some embodiments, the load 302 includes a vehicle and/or generator.

In some embodiments, a fuel cell stack 101 includes a plurality of fuel cells 200a, . . . , 200n electrically connected in series. In some examples, any of the plurality of fuel cells 200a, . . . , 200n include embodiments of the fuel cell 200 of FIGS. 2A-B. In some embodiments, the fuel cell stack 101 is an example of the fuel cell stack 101 shown in FIG. 1A and shown within the housing 192 in FIG. 1B.

In some embodiments, each of the fuel cells 200 includes an anode 204a, . . . , 204n and a cathode 202a, . . . , 202n. In some embodiments, the fuel cell stack 101 includes a number of plates 208 disposed between adjacent fuel cells 200. In some embodiments, a plate 208 is disposed between an electrode of a first type in a first fuel cell 200 and an electrode of a second type in an adjacent fuel cell. In some embodiments, each endplate 208 is a bipolar plate. In some embodiments, the endplate 208 of an anode 204a of a first fuel cell 200a is the endplate 208 of a cathode 202b of an adjacent fuel cell 200b. As such, in some embodiments, each endplate 208 includes the electrolyte inlet 212, electrolyte outlet 214, hydrogen inlet 216, hydrogen outlet 218, oxygen inlet 220, and oxygen outlet 222.

In some embodiments, the fuel cell stack 101 includes fuel cells 200 connected and/or stacked in series to generate a desired voltage. In some embodiments, each fuel cell 200 of the stack 101 generates approximately 0.8 volts at 100 milliamps per square centimeter of electrode surface area. Other fuel cell stacks may be sized differently and produce a higher or lower voltage. In some embodiments, at least one fuel cell includes a 10.6 centimeter by 10.6-centimeter electrode and generates approximately 11.2 amps of short-circuit current. In some embodiments, the fuel cell stack 101 includes a 12.8 volt open-circuit voltage generated by 16 fuel cells 200 connected and/or stacked in series. Other embodiments include more or less fuel cells 200 to produce different voltages.

In some embodiments, the fuel cell stack 101 has a substantially cubic shape. In some embodiments the fuel cell stack 101 includes 16 fuel cells 200, and each fuel cell has a surface area of approximately 15×15 cm. In some embodiments, the fuel cell stack 101 has dimensions of 15×13.1×15 cm. In other embodiments, the shape of the fuel cells 200 are rectangular, round, oblong, etc.

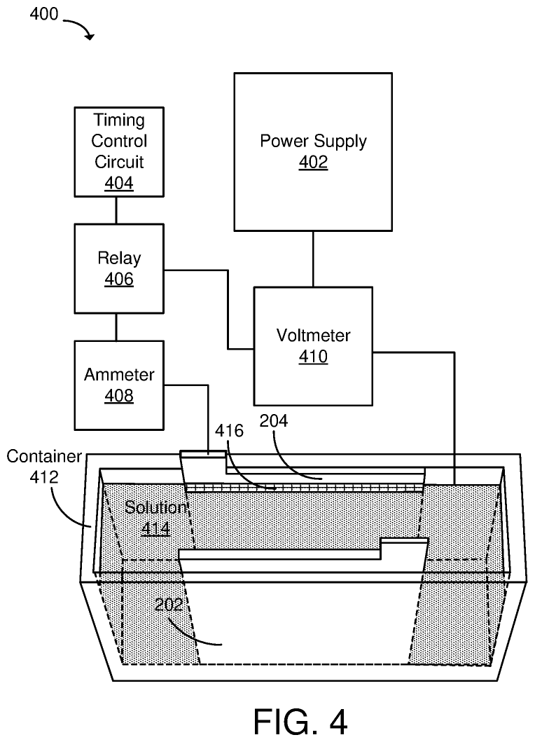

FIG. 4 is a perspective view illustrating one embodiment of a system 400 for coating an electrode (e.g., an anode 204 and/or cathode 202 of the fuel cell 200) with a catalyst. In some embodiments, the system 400 of FIG. 4 is used to coat the anode 204 and/or cathode 202 before including the anode 204 and/or cathode 202 in the fuel cell. In some embodiments, the system 400 includes a power supply 402, a timing control circuit 404, a relay 406, an ammeter 408, a voltmeter 410, a container 412, a solution 414, and a cloth 416.

In some embodiments, at least one electrode of the fuel cell includes a carbon cloth 416, and the system 400 is configured to coat the carbon cloth 416 with the catalyst. As shown in FIG. 4, in some embodiments, the anode 204 of a fuel cell 200 includes a carbon cloth 416 coated with a catalyst. As used herein, the phrase “includes a carbon cloth” includes the carbon cloth 416 being coupled, directly and/or indirectly, to the electrode in question. Although FIG. 4 only shows the carbon cloth 416 coupled to the anode 204, embodiments of the present disclosure also include a carbon cloth coupled to the cathode 202. As used herein, the term “carbon cloth” is used to refer to any carbon material arranged to at least partially cover at least one electrode of the fuel cell 200.

In some embodiments, the system 400 is configured to deposit the number of particles onto the carbon cloth 416 via electro-deposition. In some embodiments, the electro-deposition includes pulsed electro-deposition.

In some embodiments, the system 400 includes a power supply 402. In some examples, the power supply 402 is configured to supply a voltage greater than 0 V and not greater than 30 V. In some embodiments, the power supply 402 is configured to supply a current of greater than 0 A and not greater 3 A. In some examples, the power supply 402 supplies of voltage of approximately 4 V and a current of not greater than 100 milliamperes (“mA”) over a pulse period of approximately 2 seconds. In some embodiments, the system 400 includes a voltmeter 410 configured to measure voltage during the deposition pulse. However, in some embodiments, the system 400 does not include the voltmeter 410. In some embodiments, the system 400 includes an ammeter 408 configured to measure current during the deposition pulse. However, in some embodiments, the system 400 does not include the ammeter 408.

In some embodiments, the system 400 includes a timing control circuit 404. In some examples, the timing control circuit 404 is configured to provide a fixed-time voltage pulse at a voltage set on the power supply 402 to at least one of the electrodes for a given period of time. In some embodiments, the period of time is approximately 10 seconds, 10 minutes, and/or 10 hours. In some embodiments, the system 400 includes a relay 406. In some embodiments, the relay 406 is triggered by the timing control circuit 404. In some embodiments, relay 406 is configured to turn the flow of current to the electrode(s) on and/or off.

As shown in FIG. 4, in some embodiments, the container 412 receives the solution 414 and the anode 204 and/or cathode 202. In some embodiments, the solution 414 is an aqueous solution. In some embodiments, the solution 414 includes ions of a catalyst to be deposited onto the carbon cloth 416. In some embodiments, the solution 414 includes nickel ions to be deposited onto a carbon cloth 416 of the anode 204. In some embodiments, the solution 414 includes silver ions to be deposited onto a carbon cloth of the cathode 202. In some embodiments, the electric pulses from the power supply 402 cause particles of the ions in the solution 414 to be deposited onto carbon fibers of the carbon cloth 416. In some embodiments, the number of particles are non-platinum particles. In some embodiments, the catalyst includes nickel and/or silver particles.

In some embodiments, one electrode (referred to herein as the “working electrode”) includes the carbon fiber cloth 416, and the other electrode acts as a counter electrode. In some embodiments the counter electrode releases metal ions into the solution 414 as particles are being deposited onto the carbon fiber cloth 416 to help maintain the concentration of metal ions in the solution 414. In some embodiments, the counter electrode is connected to a positive terminal of the power supply 402, and the working electrode is connected to a negative terminal of the power supply 402.

In embodiments, the carbon cloth 416 includes carbon fiber. In some embodiments, the carbon cloth 416 includes a conductive material. In some embodiments, the carbon cloth 416 is porous. Some embodiments of the present disclosure include depositing the particles onto the carbon cloth 416 using 4 V open circuit voltage and 100 mA max current with a 10 second pulse. In some embodiments, the system 400 includes a carbon cloth of the cathode 202. Some embodiments include electrodepositing silver nanoparticles on that carbon cloth cathode 202 using 30 V open circuit voltage and 3 A max current with a 2 second pulse.

In some embodiments, the container 412 includes glass. In some embodiments, the anode 204 and/or cathode 202 include a metallic material, such as stainless steel.

Although not shown in FIG. 4, in some embodiments, the system 400 includes a heating element. In some embodiments, the system 400 includes a heating element positioned under the container 412 and configured to heat the solution 414 to a particular temperature. In some examples, the cathode 202 includes a carbon cloth 416, and the heating element is configured to heat the solution 414 to a temperature of not less than 15° C. and not greater than 25° C. In some examples, the anode 204 includes the carbon cloth 416, and the heating element is configured to heat the solution 414 to at least 40° C.

In some embodiments, the fuel cell 200 includes the carbon cloth 416 positioned on the anode 204 and/or cathode 202 to face the diffuser 224. In some embodiments, the anode 204 includes a carbon cloth 416 facing the diffuser 224a and influx of hydrogen. In some embodiments, the cathode 202 includes a carbon cloth 416 facing the diffuser 224b and the influx of oxygen.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A fuel cell, comprising:
an anode;
a cathode; and
an electrolyte disposed between the anode and the cathode, the electrolyte comprising an alkaline solution, the alkaline solution comprising an amine compound.

2. The fuel cell of claim 1, wherein at least one of the anode and the cathode comprises a carbon cloth coated with a catalyst.

3. The fuel cell of claim 2, further comprising:
a plate comprising an opening configured to receive a gas; and
a diffuser disposed between the plate and at least one of the anode and the cathode and configured to form electrical contact between the plate and the at least one of the anode and the cathode, the diffuser comprising a material, the material being elastic, mesh, and/or metallic,
wherein the catalyst is configured to react with the gas as the gas is diffused by the diffuser.

4. The fuel cell of claim 3, wherein:
the plate comprises a first plate positioned at a first end of the fuel cell, the first plate comprising a first opening configured to receive hydrogen, a second opening configured to allow the hydrogen to exit the fuel cell, a third opening configured to receive the electrolyte, and a fourth opening configured to allow the electrolyte to exit the fuel cell; and
the fuel cell further comprises a second plate positioned at a second end opposite to the first end, the second plate comprising a fifth opening configured to receive oxygen and a sixth opening configured as an exit for the oxygen.

5. The fuel cell of claim 4, further comprising a concentrator positioned proximate to the fifth opening, wherein the oxygen comprises oxygen in a gas, and the concentrator is configured to increase a concentration of oxygen in the gas.

6. The fuel cell of claim 1, further comprising a membrane separator disposed between the cathode and the anode, the membrane separator comprising a material that is electrically insulating, is inert to the amine compound, and/or is porous to the amine compound.

7. The fuel cell of claim 1, wherein the alkaline solution comprises a liquid solution and the electrolyte comprises an organic amine compound.

8. The fuel cell of claim 7, wherein the organic amine compound comprises dibutylamine, tripropylamine, and/or dihexylamine.

9. The fuel cell of claim 1, wherein the amine compound has a density, at 25 degrees Celsius, of not greater than 1 gram per milliliter.

10. A fuel cell, comprising:
an anode;
a cathode; and
an electrolyte disposed between the anode and the cathode, the electrolyte comprising an alkaline solution,
wherein at least one of the anode and the cathode comprises a carbon cloth coated with a catalyst.

11. The fuel cell of claim 10, wherein the alkaline solution comprises an amine compound.

12. The fuel cell of claim 11, further comprising a membrane separator disposed between the electrolyte and at least one of the cathode and the anode, wherein the membrane separator comprises a material that is electrically insulating, is inert to the amine compound, and/or is porous to the amine compound.

13. The fuel cell of claim 11, further comprising:
a reservoir configured to receive the alkaline solution, wherein:
water of the alkaline solution is separated from the amine compound as the alkaline solution passes through the reservoir; and
the reservoir comprises a drain;
a sensor configured to determine a water level of the reservoir; and
a controller configured to:
determine, based at least in part on data received from the sensor, that a water level of the reservoir is greater than or equal to a threshold water level; and
in response to the determining, perform at least one of:
transmit a notification to a user; or
actuate opening of the drain.

14. The fuel cell of claim 11, wherein the fuel cell further comprises:
a plate comprising an opening configured to receive a gas; and
a diffuser disposed between the plate and at least one of the anode and the cathode and configured to form electrical contact between the plate and the at least one of the anode and the cathode, the diffuser comprising a material, the material being elastic, mesh, and/or metallic,
wherein the catalyst is configured to react with the gas as the gas is diffused by the diffuser.

15. The fuel cell of claim 14, wherein:
the opening comprises a first opening of the plate;
the plate comprises:
a first corner, wherein the first opening is positioned proximate to the first corner;
a second corner opposite to the first corner; and
a second opening configured as an exit for the gas and positioned proximate to the second corner.

16. The fuel cell of claim 10, wherein the catalyst comprises a number of particles deposited onto the carbon cloth via pulsed electro-deposition, the number of particles comprising non-platinum particles.

17. The fuel cell of claim 16, wherein the number of particles comprise nickel and/or silver.

18. The fuel cell of claim 17, wherein:
the anode comprises the carbon cloth; and/or
the catalyst comprises nickel particles.

19. The fuel cell of claim 18, wherein:
the carbon cloth comprises a first carbon cloth; and/or
the cathode comprises a second carbon cloth coated with a number of silver particles.

20. A fuel cell stack, comprising:
a plurality of fuel cells electrically connected in series, each fuel cell comprising:
an anode;
a cathode; and
an electrolyte disposed between the anode and the cathode, the electrolyte comprising an alkaline solution, the alkaline solution comprising an amine compound; and
a plate disposed between the anode of a first fuel cell of two adjacent fuel cells of the plurality of fuel cells and the cathode of a second fuel cell of the two adjacent fuel cells of the plurality of fuel cells.
